(19) United States
(12) Patent Application Publication
(10) Pub. No.: US 2007/0189715 A1
(43) Pub. Date: Aug. 16, 2007

(54) Recording methods and systems for rewritable optical disk

(75) Inventors: Ping-Tsai Tsai, Kaohsiung City (TW); Sung-Yang Wu, Taichung Hsien (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mediatek Inc.

(21) Appl. No.: 11/345,038

(22) Filed: Feb. 1, 2006

(51) Int. Cl. H04N 5/91

(52) U.S. Cl. 386/94

(57) ABSTRACT

Recording methods and systems for a rewritable optical disk which is not formatted. Multimedia data is first written to a data area of a rewritable optical disk after receipt of a record command. Management data corresponding to the multimedia data is then written or modified to a management data area of the rewritable optical disk after receipt of a stop command from the disk drive. Thereafter, the multimedia data is appended and the management data is modified. The appendage and modification is repeated until all multimedia data is written. Finally, lead-in and lead-out areas of the rewritable optical disk are written.

### BACKGROUND

The invention relates to disk recording methods, and in particular to rewritable optical disk recording methods and systems.

Conventionally, rewritable optical disks, such as rewritable video disks, must be formatted before recording. Disk formatting is normally time-consuming. With the increase of real-time recording applications, conventional disk recording methods cannot satisfy current instant recording requirements. Thus, disk recording methods without formatting are desirable.

### SUMMARY

An exemplary embodiment of a recording method for a rewritable optical disk is provided. Multimedia data is written to a data area of a rewritable optical disk after receipt of a record command from a disk drive. Management data corresponding to the multimedia data is then written to a management data area of the rewritable optical disk after receipt of a stop command from the disk drive. If the disk already has a multimedia data in the data area, management data can be modified after new added multimedia data be written to a data area of a rewritable optical disk. The multimedia data is appended and the management data modified. Appendage and modification are repeated until all multimedia data is written to the rewritable optical disk. Finally, lead-in and lead-out areas of the rewritable optical disk are written.

### DESCRIPTION OF THE DRAWINGS

The invention can be more fully understood by reading the subsequent detailed description and examples with references made to the accompanying drawings, wherein:

FIG. 1 is a flowchart of an embodiment of a recording method for a rewritable optical disk.

FIG. 2 is a diagram of an embodiment of a recording system for a rewritable optical disk.

FIG. 3 is a flowchart of an embodiment of a recording method for a rewritable optical disk.

FIG. 4 is a diagram of an embodiment of a recording system for a rewritable optical disk.

FIG. 5 is a flowchart of an exemplary embodiment of a recording method for a rewritable optical disk.

FIG. 6a-6e are diagrams an exemplary embodiment of data recording for a rewritable optical disk.

FIG. 7a-7c are diagrams an exemplary embodiment of padding.

### DESCRIPTION

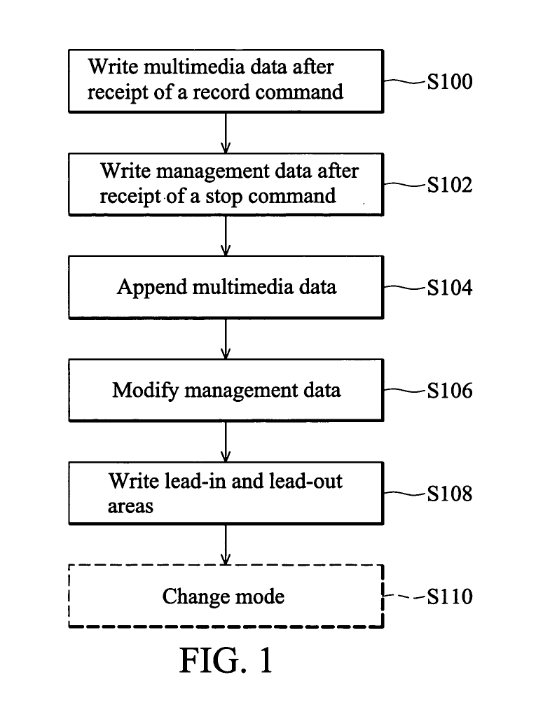

A recording method for a rewritable optical disk is provided. FIG. 1 is a flowchart of an embodiment of a recording method for a rewritable optical disk. Multimedia data is written to a data area of the rewritable optical disk after receipt of a record command from the disk drive (step S100). The multimedia data can be audio, video, or audio/video data. Management data corresponding to the multimedia data is written or modified to a management data area of the rewritable optical disk after receipt of a stop command from the disk drive (step S102). The stop command may be issued by a user. Multimedia data can comprise audio, video, or audio/video data.

The multimedia data is then appended (step S104) and the management data is modified (step S106) according to the new appended multimedia data. The appendage and modification are repeated until the multimedia data is written to the rewritable optical disk. Lead-in and lead-out areas of the rewritable optical disk are finally written (step S108), if a user wants to finalize disk.

The disk can be changed from a sequential write mode to an overwrite mode (step S110). The mode change is accomplished by first determining whether padding of the rewritable optical disk is necessary, and if so, the rewritable optical disk is searched and pad areas are located. Zeros are filled into the located pad areas. Lead-in and lead-out areas of the rewritable optical disk are finally written.

Here, mode change of the rewritable optical disk can be executed beforehand. For example, if the multimedia data is written completely without data appendage or modification, the mode change may be executed after data is written, i.e. step S102.

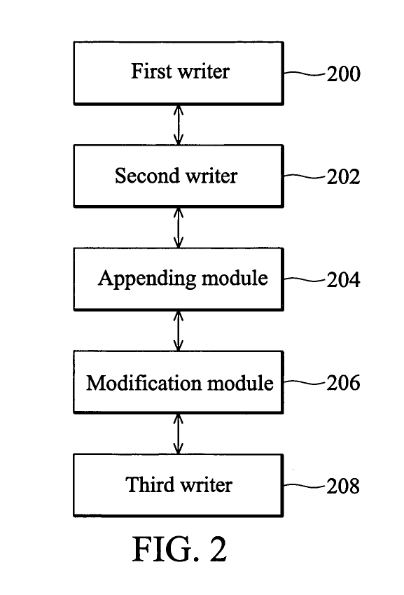

FIG. 2 is a diagram of an embodiment of a recording system for a rewritable optical disk. A recording system for a rewritable optical disk in a disk drive is provided. The provided recording system comprises a first writer 200, a second writer 202, an appending module 204, a modification module 206, and a third writer 208.

The first writer 200 writes multimedia data, such as audio, video, or audio/video data, to a data area of the rewritable optical disk after receipt of a record command from the disk drive. The second writer 202, coupled to the first writer 200, writes or modifies management data corresponding to the multimedia data to a management data area of the rewritable optical disk after receipt of a stop command. The second writer 202 changes the rewritable optical disk from a sequential write mode to an overwrite mode, as following steps. The second writer 202 determines if padding of the rewritable optical disk is necessary. If so, the second writer 202 searches the rewritable optical disk and locates pad areas. The second writer 202 fills zeros into the pad areas and writes lead-in and lead-out areas of the rewritable optical disk.

The appending module 204, coupled to the second writer 202, appends the multimedia data. The modification module 206, coupled to the appending module 204, modifies the management data. The third writer 208, coupled to the modification module 206, writes lead-in and lead-out areas of the rewritable optical disk. The appending and modification modules 204 and 206 write appendage and modification until the multimedia data is written to the rewritable optical disk.

The third writer 208 changes the rewritable optical disk from a sequential write mode to an overwrite mode by determining if padding of the rewritable optical disk is necessary, searching the rewritable optical disk and locating pad areas, and if so, filling zeros into the pad areas and writing lead-in and lead-out areas of the rewritable optical disk. The mode change is executed by the second writer 202 or the third writer 208, depending on the data written status.

As described, the provided systems and methods record multimedia data without the need for disk formatting, showing time saving results in real-time rewritable optical disk recording.

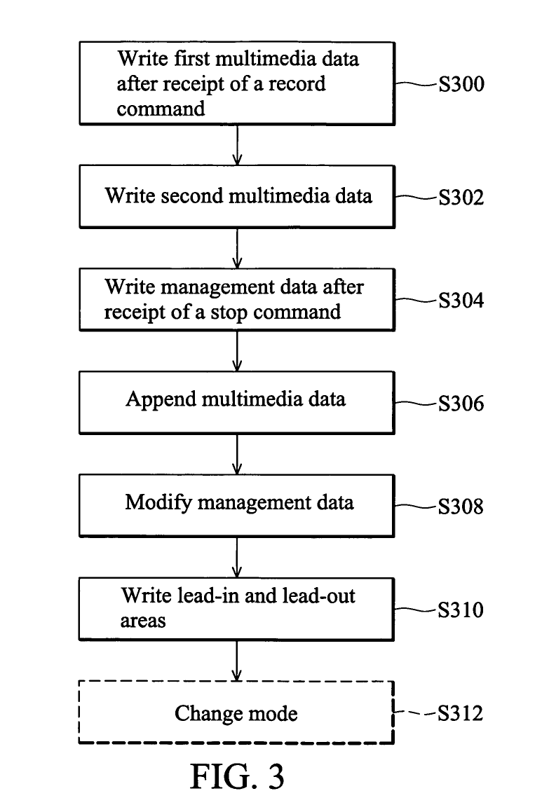

The multimedia data can be written in several stages. FIG. 3 is a flowchart of an embodiment of a recording method for a rewritable optical disk. First multimedia data is written to a first data area of the rewritable optical disk after receipt of a record command from the disk drive (step S300). Second multimedia data is written to a second data area of the rewritable optical disk (step S302). Management data corresponding to the first and second multimedia data is written or modified to a management data area of the rewritable optical disk after receipt of a stop command from the disk drive (step S304). The multimedia data includes audio, video, or audio/video data

The first and second multimedia data is appended (step S306) and the management data is modified (step S308). The appendage and modification is repeated until the first and second multimedia data is written to the rewritable optical disk. Lead-in and lead-out areas of the rewritable optical disk are finally written (step S310).

Thereafter, the rewritable optical disk is changed from a sequential write mode to an overwrite mode (step S312). The change is accomplished by first determining whether padding of the rewritable optical disk is necessary. If so, the rewritable optical disk is searched and pad areas are located. Zeros are filled into the located pad areas. Lead-in and lead-out areas of the rewritable optical disk are finally written.

Here, again, mode change of the rewritable optical disk can be executed beforehand. For example, if the first and second multimedia data is written completely, and does not require appendage or modification, the mode change may be executed after data is written, i.e. step S304.

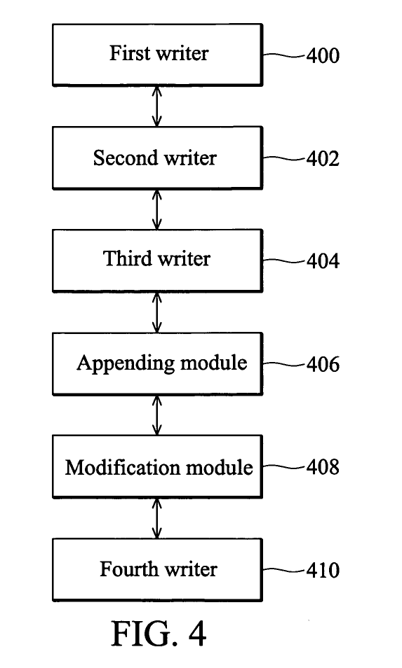

FIG. 4 is a diagram of an embodiment of a recording system for a rewritable optical disk. A recording system for a rewritable optical disk comprises a first writer 400, a second writer 402, a third writer 404, an appending module 406, a modification module 408, and a fourth writer 410.

The first writer 400 writes first multimedia data to a first data area of the rewritable optical disk after receipt of a record command. The second writer 402, coupled to the first writer 400, writes second multimedia data to a second data area of the rewritable optical disk. The third writer 404, coupled to the second writer 402, writes or modifies management data, corresponding to the first and the second multimedia data, to a management data area of the rewritable optical disk after receipt of a stop command.

The third writer 404 changes the rewritable optical disk from a sequential write mode to an overwrite mode as follows. The third writer 404 first determines if padding of the rewritable optical disk is necessary. If so, the third writer 404 searches the rewritable optical disk and locates pad areas. The third writer 404 then fills zeros into the pad areas and writes lead-in and lead-out areas of the rewritable optical disk.

The appending module 406, coupled to the third module 404, appends the first and the second multimedia data. The modification module 408, coupled to the appending module 406, modifies the management data. The fourth writer 410, coupled to the modification module 408, writes lead-in and lead-out areas of the rewritable optical disk. The appending and the modification modules 406 and 408 repeat appendage and modification until all the first and second multimedia data is written to the rewritable optical disk.

If the multimedia data is written with appendage and modification, the mode change is executed by the fourth writer 410. The fourth writer 410 changes the rewritable optical disk from a sequential write mode to an overwrite mode as follows. The fourth writer 410 determines if padding of the rewritable optical disk is necessary. If so, the fourth writer 410 searches the rewritable optical disk and locates pad areas. The fourth writer 410 then fills zeros into the pad areas and writes lead-in and lead-out areas of the rewritable optical disk.

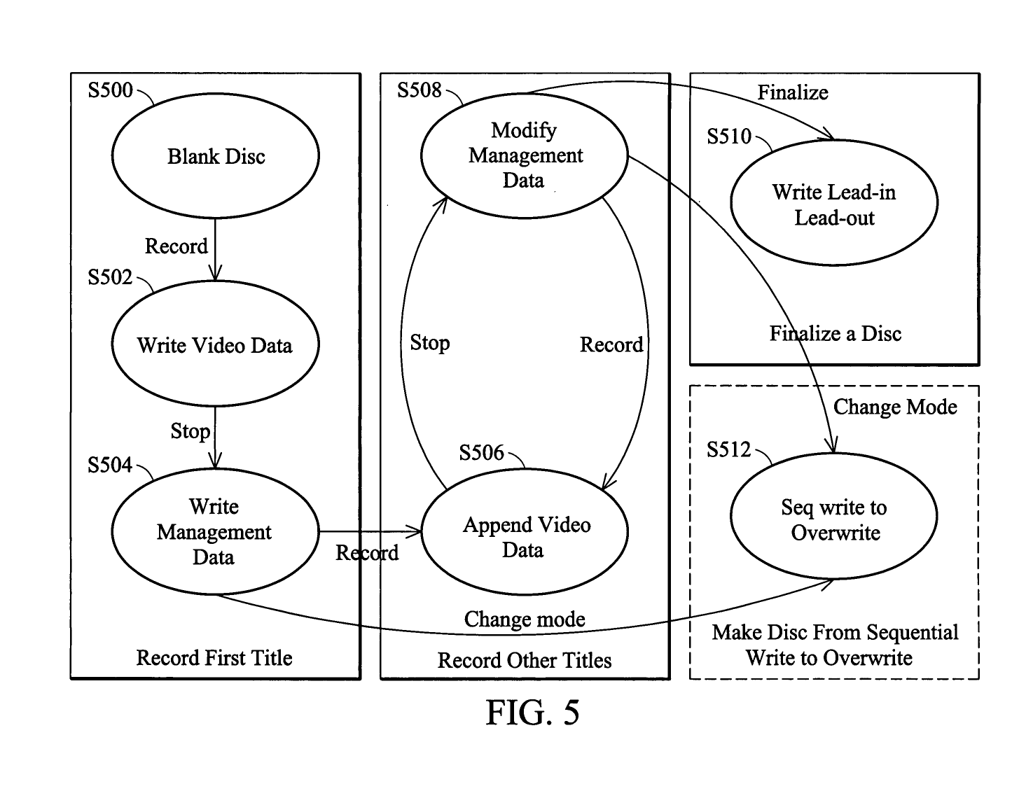

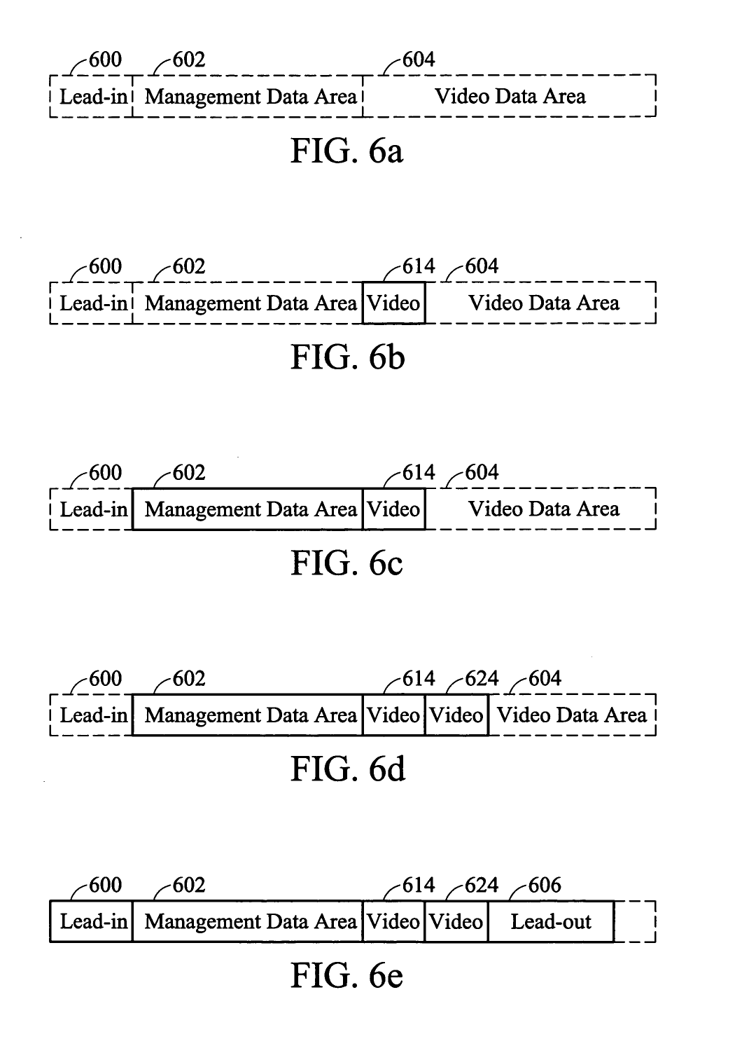

FIG. 5 is a flowchart of an exemplary embodiment of a recording method for a rewritable optical disk in a disk drive. In this exemplary embodiment, a blank rewritable video disk is first placed in a digital disk recorder (DVR) (Step S500). General format of the blank video disk is shown in FIG. 6a and comprises a lead-in area 600, a management data area 602, and a video data area 604.

A record command is received from the DVR and video data 614 is written to the video data area 604 thereafter (step S502) as shown in FIG. 6b.

A stop command is received from the DVR. Management data 612 corresponding to the video data 614 is written or modified to the management data area 602 of the rewritable video disk after receipt of the stop command from the disk drive (step S504), shown in FIG. 6c.

The video data 624 is appended (step S506) and the management data 612 is modified (step S508) until the video data is written to the rewritable video disk as shown in FIG. 6d. Finally, lead-in and lead-out areas, 600 and 606, of the rewritable video disk are finally written (step S510) as shown in FIG. 6e, if a user wants to finalize the disk.

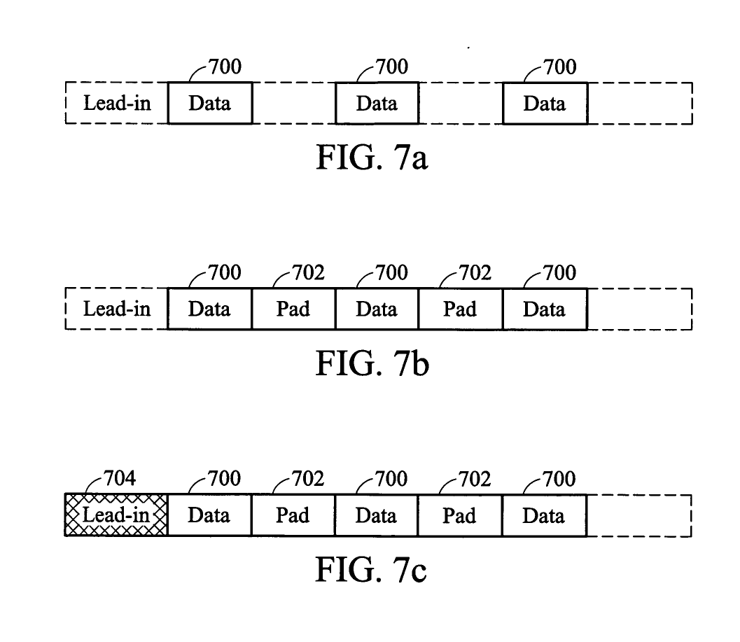

Thereafter, the rewritable video disk can be changed from a sequential write mode to an overwrite mode (step S512). Video data 700 may be written to a rewritable video disk separately. Some pad areas 702 are inserted in data areas as shown in FIG. 7a. Thus, padding of the rewritable video disk is determined to be necessary. The rewritable video disk is searched and pad areas are located. Zeros are filled into the located pad areas 702 as FIG. 7b. Lead-in area 704 of the rewritable video disk is finally written as shown in FIG. 7c.

Here, again, if the data is written completely in step S502, mode change of the rewritable video disk can be executed beforehand.

Methods and systems of the present disclosure, or certain aspects or portions of embodiments thereof, may take the form of program code (i.e., instructions) embodied in media, such as floppy diskettes, CD-ROMS, hard drives, firmware, or any other machine-readable storage medium, wherein, when the program code is loaded into and executed by a machine, such as a computer, the machine becomes an apparatus for practicing and embodiment of the disclosure. The methods and apparatus of the present disclosure may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing and embodiment of the disclosure. When implemented on a general-purpose processor, the program code combines with the processor to provide a unique apparatus that operates analogously to specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents

What is claimed is:

1. A recording method for a rewritable optical disk, comprising:
writing multimedia data to a data area of the rewritable optical disk which is not formatted after receipt of a record command; and
writing management data corresponding to the multimedia data to a management data area of the rewritable optical disk after receipt of a stop command.

2. The recording method for a rewritable optical disk as claimed in claim 1, further comprising changing the rewritable optical disk from a sequential write mode to an overwrite mode.

3. The recording method for a rewritable optical disk as claimed in claim 2, wherein the change further comprises:
determining if padding of the rewritable optical disk is necessary;
filling zeros into searched pad areas if padding is necessary; and
writing lead-in and lead-out areas of the rewritable optical disk.

4. The recording method for a rewritable optical disk as claimed in claim 1, further comprising:
appending first multimedia data;
modifying second management data; and
writing lead-in and lead-out areas of the rewritable optical disk.

5. The recording method for a rewritable optical disk as claimed in claim 4, further comprising changing the rewritable optical disk from a sequential write mode to an overwrite mode.

6. The recording method for a rewritable optical disk as claimed in claim 5, wherein the change further comprises:
determining if padding of the rewritable optical disk is necessary;
filling zeros into searched pad areas if padding is necessary; and
writing lead-in and lead-out areas of the rewritable optical disk.

7. A recording method for a rewritable optical disk, comprising:
modifying previous management data corresponding to previous written multimedia data to a management data area of the rewritable optical disk after receipt of a stop command.

8. The recording method for a rewritable optical disk as claimed in claim 7, further comprising changing the rewritable optical disk from a sequential write mode to an overwrite mode.

9. The recording method for a rewritable optical disk as claimed in claim 7, wherein the change further comprises:
determining if padding of the rewritable optical disk is necessary;
filling zeros into searched pad areas if padding is necessary; and
writing lead-in and lead-out areas of the rewritable optical disk.

10. A recording method for a rewritable optical disk, comprising:
writing first multimedia data to a first data area of a rewritable optical disk after receipt of a record command from a disk drive;
writing second multimedia data to a second data area of the rewritable optical disk; and
writing management data corresponding to the first and the second multimedia data to a management data area of the rewritable optical disk after receipt of a stop command from the disk drive.

11. The recording method for a rewritable optical disk as claimed in claim 10, further comprising changing the rewritable optical disk from a sequential write mode to an overwrite mode.

12. The recording method for a rewritable optical disk as claimed in claim 11, wherein the change further comprises:
determining if padding of the rewritable optical disk is necessary;
filling zeros into searched pad areas if padding is necessary; and
writing lead-in and lead-out areas of the rewritable optical disk.

13. The recording method for a rewritable optical disk as claimed in claim 11, further comprising:
appending third multimedia data;
modifying the management data corresponding to the third multimedia data; and
writing lead-in and lead-out areas of the rewritable optical disk.

14. The recording method for a rewritable optical disk as claimed in claim 13, further comprising changing the rewritable optical disk from a sequential write mode to an overwrite mode.

15. The recording method for a rewritable optical disk as claimed in claim 14, wherein the change further comprises:
determining if padding of the rewritable optical disk is necessary;
filling zeros into searched pad areas if padding is necessary; and
writing lead-in and lead-out areas of the rewritable optical disk.

16. A recording system for a rewritable optical disk, comprising:
a first writer, writing multimedia data to a data area of the rewritable optical disk which is not formatted after receipt of a record command; and
a second writer, coupled to the first writer, writing management data corresponding to the multimedia data to a management data area of the rewritable optical disk after receipt of a stop command.

17. The recording system for a rewritable optical disk as claimed in claim 16, wherein the second writer further changes the rewritable optical disk from a sequential write mode to an overwrite mode.

18. The recording system for a rewritable optical disk as claimed in claim 17, wherein the second writer further determines if padding of the rewritable optical disk is necessary, fills zeros into searched pad areas if padding is necessary, and writes lead-in and lead-out areas of the rewritable optical disk.

19. The recording system for a rewritable optical disk as claimed in claim 16, further comprising:
an appending module, coupled to the second writer, appending first multimedia data;
a modification module, coupled to the appending module, modifying second management data; and
a third writer, coupled to the modification module, writing lead-in and lead-out areas of the rewritable optical disk.

20. The recording system for a rewritable optical disk as claimed in claim 19, wherein the third writer further changes the rewritable optical disk from a sequential write mode to an overwrite mode.

21. The recording system for a rewritable optical disk as claimed in claim 20, wherein the third writer further determines if padding of the rewritable optical disk is necessary, fills zeros into searched pad areas if padding is necessary, and writes lead-in and lead-out areas of the rewritable optical disk.

22. A recording system for a rewritable optical disk, comprising:
a modification module, modifying previous management data corresponding to previous written multimedia data to a management data area of the rewritable optical disk after receipt of a stop command.

23. The recording system for a rewritable optical disk as claimed in claim 22, wherein the modification module further changes the rewritable optical disk from a sequential write mode to an overwrite mode.

24. The recording system for a rewritable optical disk as claimed in claim 22, wherein the modification module further determines if padding of the rewritable optical disk is necessary, fills zeros into searched pad areas if padding is necessary, and writes lead-in and lead-out areas of the rewritable optical disk.

25. A recording system for a rewritable optical disk, comprising:
a first writer, writing first multimedia data to a first data area of a rewritable optical disk after receipt of a record command from a disk drive;
a second writer, coupled to the first writer, writing second multimedia data to a second data area of the rewritable optical disk; and
a third writer, coupled to the second writer, writing management data corresponding to the first and the second multimedia data to a management data area of the rewritable optical disk after receipt of a stop command from the disk drive.

26. The recording system for a rewritable optical disk as claimed in claim 25, further comprising changing the rewritable optical disk from a sequential write mode to an overwrite mode.

27. The recording system for a rewritable optical disk as claimed in claim 26, wherein the third writer further determining if padding of the rewritable optical disk is necessary, filling zeros into searched pad areas if padding is necessary, and writing lead-in and lead-out areas of the rewritable optical disk.

28. The recording system for a rewritable optical disk as claimed in claim 26, further comprising:
an appending module, coupled to the third writer, appending third multimedia data;
a modification module, coupled to the appending module, modifying the management data; and
a fourth writer, coupled to the modification module, writing lead-in and lead-out areas of the rewritable optical disk.

29. The recording system for a rewritable optical disk as claimed in claim 28, wherein the fourth writer further changes the rewritable optical disk from a sequential write mode to an overwrite mode.

30. The recording system for a rewritable optical disk as claimed in claim 29, wherein the fourth writer further determines if padding of the rewritable optical disk is necessary, fills zeros into searched pad areas if padding is necessary, and writes lead-in and lead-out areas of the rewritable optical disk.

31. A digital video recorder, comprising:
a first writer, writing multimedia data to a data area of the rewritable optical disk which is not formatted after receipt of a record command; and
a second writer, coupled to the first writer, writing management data corresponding to the multimedia data to a management data area of the rewritable optical disk after receipt of a stop command.
